(19) United States
(12) Patent Application Publication
(10) Pub. No.: US 2014/0102849 A1
(43) Pub. Date: Apr. 17, 2014

(54) CASH MANAGEMENT SYSTEM WITH REPLENISHMENT AND DEPOSIT CAPABILITY

(71) Applicant: PlutusCode Inc., Hamilton (CA)

(72) Inventor: Qi LI, Oakville (CA)

(73) Assignee: PlutusCode Inc., Hamilton (CA)

(21) Appl. No.: 14/047,365

(22) Filed: Oct. 7, 2013

Related U.S. Application Data
(60) Provisional application No. 61/712,319, filed on Oct. 11, 2012.

(51) Int. Cl. G07D 1/06; G07D 11/00

(52) U.S. Cl. CPC G07D 1/06; G07D 11/0084
USPC 194/206

(57) ABSTRACT

An apparatus and method is disclosed for the retention of currency in the nature of coins and bills, within a transactional terminal, for replenishment of a change dispenser and future distribution in the form of change, as well as the storage in a secure safe of larger denomination bills for which credit may be applied to a financial account prier to the actual deposit of such bills at a financial institution. A system incorporating the apparatus and method may further provide for the overall management of cash receipts whereby a running balance is recorded and acted upon, for example when a change dispenser is empty, a change retention buffer is full, or the large-denomination bill vault is emptied.

The following disclosure relates to the management of cash within a retail or similar point-of-sale environment. More particularly, the disclosed cash management system and method minimizes access to cash by managing both cash receipts and the dispensing of change, while concurrently recording and isolating cash (e.g. bills) above a threshold denomination in order to provide a secure collection/deposit mechanism whereby such funds may be credited and available prior to their receipt by a bank or similar financial institution.

### BACKGROUND & SUMMARY

Traditionally, in a retail or other point-of-sale environment, it is customary to engage in an exchange of currency, where a customer tenders more than an amount necessary to cover the purchase price, which requires a subsequent exchange of change from a cashier to reconcile the transaction or “change back”. More often than not this back and forth exchange of currency is accurate, however due to human interaction it is inevitable that errors will occur within the transaction. It is also the case that the more that humans are involved with the handling and management of cash, the greater the likelihood that theft may take place (by third parties as well as employees), in an attempt to mitigate losses due to change back errors and theft the disclosed cash management system seeks to reduce human interactions with cash in the business.

Automatic change or coin return mechanisms have been devised to mitigate human intervention within a transaction. There is also a recent trend to implement self-checkout kiosks whereby the customer's money is inserted and their change is automatically dispensed, along with a receipt. Although self-checkout eliminates the cashier from the transaction it also promotes the opportunity for theft of goods, accordingly a compromise solution will generally include a cashier, in the embodiments disclosed herein the currency transaction includes the insertion of the bills and coins into a secured system, not a cash drawer, and any change (coins and bills) is automatically dispensed back to the customer.

Accordingly, the disclosed embodiments describe a system that automates cash deposits and cash payouts to streamline the cash flow process at a point-of-sale or cashier station, for example in a retail transaction. The embodiments generally Comprise three elements; a change dispenser (referred to as a Change Terminal), a cash repository (referred to as a Cash Server), and a network-based monitoring software program (referred to as a LinkHost). The secure money management system is capable of functioning offline or networked to a back office and a financial institution through the LinkHost and an associated Internet/Intranet connection. Additionally, even in an offline mode, one Cash Server can support multiple Change Terminals. The LinkHost monitoring application software monitors the cash balance of the Cash Server and Change Terminals to optimize the replenishment of the change buffer(s), as well as monitoring the secure transfer of accumulated bills from the Cash Server to a financial institution on a periodic or as-needed basis.

Disclosed in embodiments herein is a secure cash management system for a point of sale location(s), comprising: a cash server including separate and independently accessible first and second compartments therein; a coin acceptor associated with said first compartment, said coin acceptor validating the coins, which then drop into the coin sorter to be sorted before storing the coins within said first compartment; a small denomination bill acceptor, also associated with said first compartment, for receiving bills equal to or below a threshold bill denomination; a large denomination bill acceptor associated with said second compartment for receiving bills above the threshold bill denomination, recording (the coin and bill changes also recorded, but are kept separately) the “deposit” of such bills, and storing the bills within an enclosure in said second compartment, said enclosure being a sealable enclosure (e.g., cassette or bag); a change terminal for dispensing chance for a point of sale transaction in the form of bills equal to or below the threshold bill denomination and coins, when necessary, said change terminal including a bill dispenser for dispensing bills equal to or below the threshold bill denomination, wherein the bills used to replenish the supply of bills in said bill dispenser are from those bills stored in the first compartment; and a coin dispenser wherein coins used to replenish the supply in said coin dispenser are, at least in part, from those stored in the first compartment.

In one embodiment the disclosed system has separate and partitioned sections, at least a first section for the Cash Server to accept and store funds and a second section for the Change Terminal to dispense change to a customer. The first section is further divided into discrete money acceptors; a first acceptor for coins, a second for large denomination bills, that records the storing of such bills within a secure vault, and a third acceptor for small bills that are to be retained within the Cash Server for subsequent use to replenish the Change Terminal. The accumulated amount of the deposited large bills is he transmitted in near real-time to a back office, as well as to the designated financial institution and/or Armored Courier, as an immediate credit posted to the business' account. The aforementioned second section may also include a display unit for indicating the exact amount of cash to be automatically paid out to the customer.

Also disclosed in the described embodiments is a method for operating a secure cash management system, comprising: accepting bills via a cash server; said cash server verifying the authenticity of the bills: determining the denomination of the bills; storing bills equal to and below a threshold denomination in a first storage compartment; storing, and counting, bills above a threshold denomination in a second secure compartment, separate from all other bills or coins; accepting coins via the cash server; sorting coins by denomination and storing the sorted coins in the first storage compartment; using a separate change terminal, dispensing coins and bills equal to and below a threshold denomination to the customer as required to make change for a transaction; and periodically replenishing the coins and bills in said change dispenser using, at least in part, coins and bills from said first storage compartment.

Also disclosed is a method performed within the CashServer to accept, validate and sort coins and bills into their respective denominations. At least one Change Terminal includes a bill and coin dispenser and further comprises a replenishment method whereby the coins and small denomination bills retained within the Cash Server are periodically transferred to the Change Terminal to replenish, at least in part, the cash required to provide the change to complete a customer transaction.

### BRIEF DESCRIPTION OF THE DRAWINGS

FIG. 1 is a block diagram depicting the overall configuration of a cash handling system;

FIG. 2 is a system flow chart for a cash handling system such as depicted in FIG, 1:

FAG. 3 is a perspective view of a preferred embodiment of a transaction terminal; and

FIG. 4 is a front view of the preferred embodiment of the terminal in FIG. 3, showing the change terminal features.

The various embodiments described herein are not intended to limit the disclosure to those embodiments described. On the contrary, the intent is to cover all alternatives, modifications, and equivalents as may be included within the spirit and scope of the various embodiments, and equivalents set forth. For a general understanding, reference is made to the drawings. In the drawings, like references have been used throughout to designate identical or similar elements, it is also noted that the drawings may not have been drawn to scale and that certain regions may have been purposely drawn disproportionately so that the features and aspects could be properly depicted.

### DETAILED DESCRIPTION

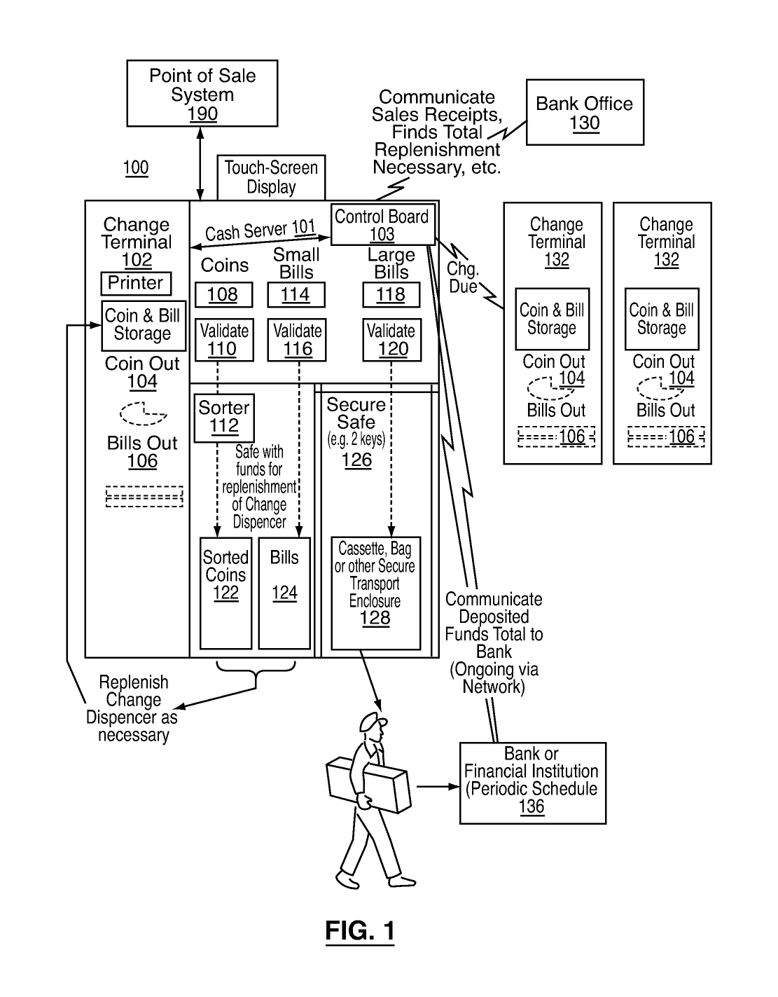

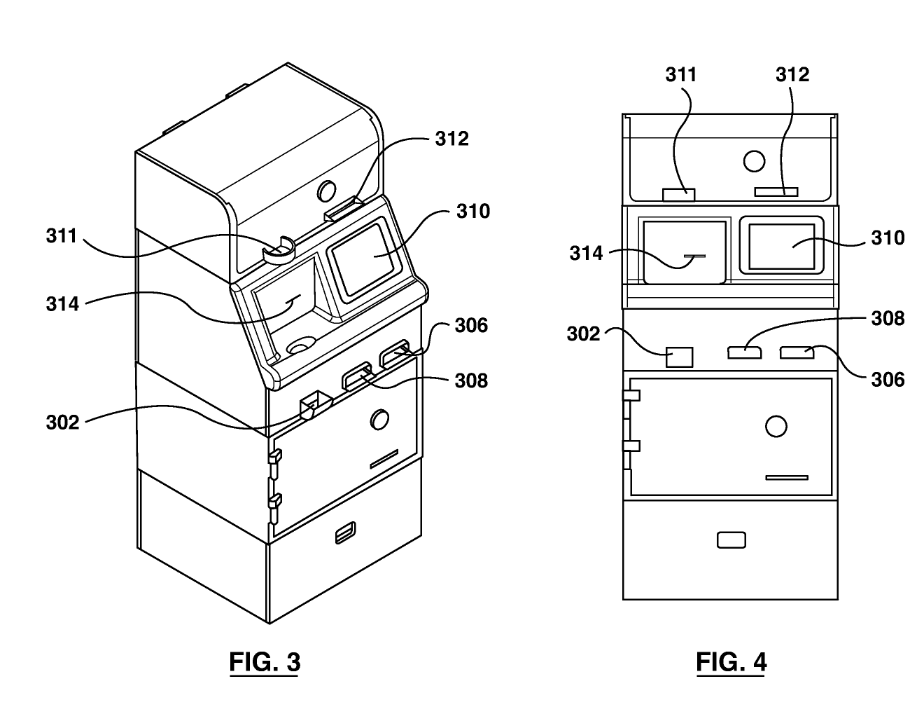

The aforementioned aspects and other objectives and advantages of the disclosed cash management systems and methods can be achieved as described in the following detailed description. Generally, the disclosed embodiments provide for an electronically assisted cashier combined with a secure cash control system that may be deployed in a single unit stand-alone configuration, as well as a multi-unit configuration. The disclosed embodiments may include at least one point-of-sale terminal, although a POS terminal is not necessary as a cashier may also be able to input the data to the system using conventional techniques. The system may also include a computer controlled operating system (e.g., within the Cash Server 101 of FIG. 1) configured to communicate with a back office in conjunction with a financial institution (e.g., bank, cash clearinghouse, etc). The control system further includes a processor programmed to control a process of counting the funds (coins and bills) tendered for payment and delivering change through one or more change return mechanisms referred to as Cash Servers. The control system also operates as a system controller or other processor-based device as represented by control board 103, to receive and accumulate financial and operational information such as the balance of cash in any of the various repositories or compartments of each Cash Server and/or Change Terminal. Continuing to refer to FIG. 1, the disclosed embodiments for a secure cash management system 100 may comprise at least three components. One component is a point-of-sale register (POS 190) other means for entering transaction information, such as a numeric keypad and display, a Par-code scanning device, touch-screen (for purchase entry and display), a money capture unit shown as a Cash Server 101, and a money dispensing unit illustrated as Change Terminals 102 and 132, the details of which are further described below relative to FIGS. 3 and 4. The point-of-sale system may be any conventional system, including those having a UPC scanner, and are capable of performing amount due calculations and feeding such information to the Cash Server. For the purpose of this disclosure, such point-of-sale systems are considered to be known in the art of sales and particularly retail operations. In one embodiment contemplated, the POS system functionality may be incorporated into the Cash Server, if so desired.

Now it is well understood in a conventional point-of-sale operation that a cashier will typically remove large bills such as $20, $50 and $100 and place them under the money tray in the register, or at least in a separate area of the cash drawer, knowing full well that these larger bills will never be required to make change and further present a risk for theft. Similarly, the system disclosed herein recognizes the need to securely store large bills for subsequent removal and deposit. The disclosed secure cash management system also solves the problem of funds for replenishing a change terminal (e.g., coins and small denomination bills) by separately retaining within the Cash Server all those denominations which can be utilized for providing change back to the customer.

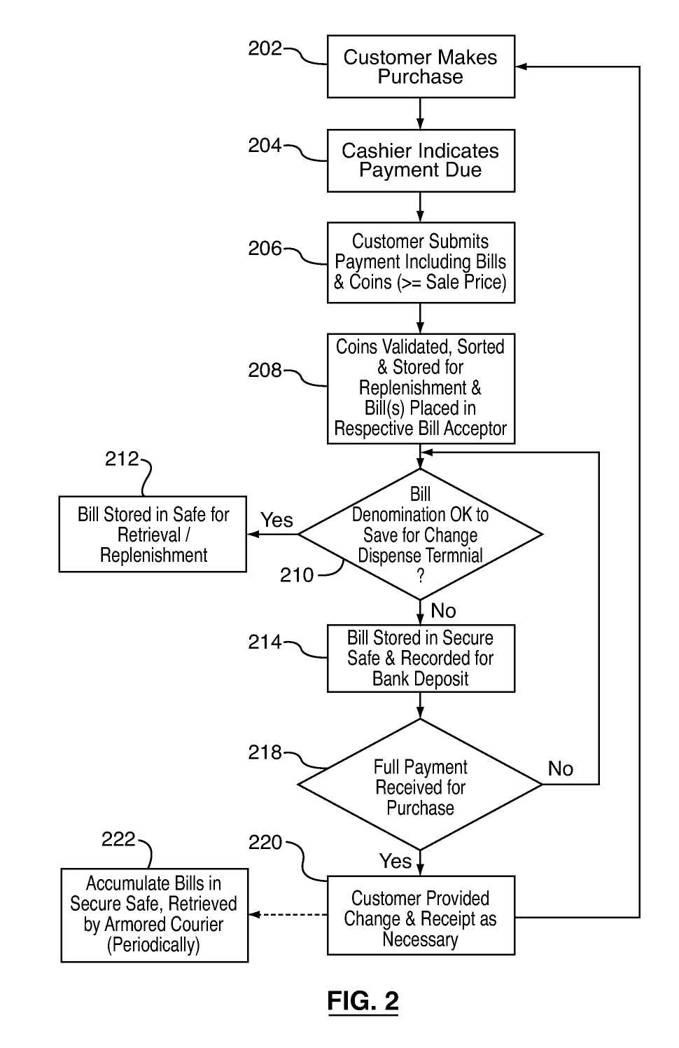

Referring again to FIG. 1, in view of the flow chart of FIG. 2, depicted therein is an exemplary diagram of the functional elements of the secure cash management system 100. As can be seen the cashier is provided three cash input options for depositing a payment; aperture 108 for coins, and two bill acceptors, one for small bill denominations 114 arid one for large bill denominations 118. Each of the inputs includes a validation subsystem 110, 116, and 120, respectively, whereby any rejected funds are immediately returned to the customer. Once a coin is verified for authenticity including country of origin, it is further processed by sorter 112 into discrete denominations and then stored in repository 122 (e.g., within tubes, sleeves, bins. etc) for subsequent replenishment of the Change Terminals 102 and 132, as change back to the customer. In like manner the small denomination bills (e.g., less than or equal to a $5 threshold), such as the $1.00 and $5.00 USD and the $5 CND are also checked for counterfeiting, country of origin and denomination and then stacked in bill buffer(s) 124 for future dispensing. Now, as previously mentioned, the bulk of the large bills are also validated at 120, however these higher denomination bills are immediately placed into secure enclosure 126. Enclosure 126 has as heightened security mechanism (e.g., having a two key access) and the bills stored therein are placed into and may be sealed in an enclosure 128 for transport. Enclosure 128, which may include a cassette, money bag or other impenetrable transport device can be sealed upon collection, which occurs on a periodic basis, and is then securely delivered to financial institution 130 via courier such as an armored car service etc.

Concurrent with the validation process, the bill denomination is determined and the accumulated balance of the funds contained within the secure safe or vault 126, is recorded. The balance of funds in the secure safe is tracked in real-time and periodically transmitted via the LinkHost 134 or alternative communications channel to both the back office 130 and/or the financial institution 136. Due to the secure nature and limited access to the secure safe 126, the funds therein may be made available by the financial institution as immediate credit to the business' account. Additionally, the LinkHost application 134 communicates sales receipts, total cash balances and change replenishment requirements to the cashier, as well as to the back office. Change Terminal 102 is depicted, in one embodiment, as being integrated with Cash Server 101, however, as also depicted in FIG. 1, it is possible to have one or more non-integrated change dispensers 132 as a discrete change operations which are also controlled via Cash Server 101. The primary purpose of multi-change dispensers is to increase the throughput of the check-out process by allowing two or more customers to secure their purchase, receipt and change substantially at the same time. This is considered advantageous where a cashier is handling multiple transactions by checking out a multitude of customers, for example, on both sides of a checkout station having at least two lanes. Change Terminals 102 and 132 are periodically replenished with funds on demand, as determined by the LinkHost network communications, the head cashier or by management personnel, it is further contemplated that integrated Change Terminal 102 as well as auxiliary terminals 132 could be replenished directly from the funds in repositories 122 and 124, however this assumes that the incoming cash would be sufficient to fulfill the returned cash combinations required to make change on an ongoing bass.

FIG. 2 illustrates, in more detail, a possible process executed by a controller that operates the secure cash management system, and in particular the cash management terminal 100 including the combined functions of Cash Server 101 and Change Terminal(s) 102. The process is initiated by a customer approaching the cashier for a purchase as reflected in step 202. The cashier determines the amount due via the point-of-sale system as represented at step 204, which may be displayed on a customer viewable screen. Payment is tendered by the customer at step 206, which is generally in excess of the balance due. Subsequently the cashier deposits the received funds into their respective coin and bill acceptors, keeping in mind to separate the large and small bill denominations. Notably the validation process of 208, and onto step 210, may also include the capability for rejection of small bills that have been mistakenly inserted into the large bill receptor 118 and vice versa. Within step 208, the coins are sorted and stored in the change repository 122 so they are available for subsequent replenishment of the Change Terminal 102. Similarly, small denomination bills are stored in repository 124 as reflected in step 212. The process executes a loop in steps 210-218 until each inserted bill has been successfully captured into Cash Server 101 either as a high value secured bill in 214 or a small bill used for change in step 212. The loop is terminated once full payment has been received as determined in step 218. At that time cash intake is completed, the required amount of change due is calculated and transmitted to Change Terminal 102 for subsequent dispensing of funds as change back to the customer at step 220. The physical transferring of funds to the bank or for replenishment are periodic and therefore not within the real time flow of the process, however, step 222 represents the periodic retrieval of the accumulated large denomination bills based upon the above-disclosed tracking or the balance or the secure vault 126—where the LinkHost transmits operational data to and from the back (accounting) office as well as a financial institution.

Having now described the operational aspects of the secure cash management systems and methods, attention is turned to FIGS. 3 and 4, which depict exemplary hardware mechanisms to facilitate the features of the disclosed embodiments, particularly, the Cash Server 101 and Change Terminal 102. The view of FIG. 3 is from the perspective of a cashier having at their disposal three money input options including: coin acceptor 302, small denomination bill acceptor 308 and large denomination bill acceptor 306. Additionally, a touch screen display 310 provides communications prompts for amount due, amount received and change required. The touch-screen display may also include status monitors indicating the requirement for intervention, such as to securely seal and remove the large bill container from vault

FIG. 4 is a depiction of the exemplary cash management system, from a front view, whereby change provided in coins are retrieved from opening 311 and bills are fed out from slot 312. Also included in the Change Terminal 102 is a printer or similar output device suitable for creating a customer receipt on paper or similar media. Such a receipt would be dispensed from slot 314, but may also be dispensed via slot 312 with a user's change. It will be appreciated that the printer may also be operated to output a deposit record or similar information as may be used in a business using the disclosed system (e.g., a deposit receipt at the time funds are retrieved from the secure storage safe).

The cashier, once again having three money input options including: coin acceptor 302, small denomination bill acceptor 308 and large denomination bill acceptor 306. Additionally, a touch screen display 310 provides communications prompts for amount due, amount received and change required. The touch-screen display may also include status monitors indicating the requirement for intervention, such as to securely seal and remove the large bill container from the vault and/or replenish the Change Terminal.

The change dispensing component from the customer's viewpoint, whereby change provided in coins are retrieved from opening 311 and bills are fed out from slot 312. Also included in the Change Terminal 102 may be a printer or similar output device suitable for creating a customer receipt on paper or similar media. Such a receipt would be dispensed from a dedicated slot (not shown or may also be dispensed via slot 312 with a user's change. It will be appreciated that the printer may also be operated to output a deposit record or similar information as may be used in a business using the disclosed system as previously noted.

As will be appreciated one or more of the disclosed embodiments may also find application in the ser industry such as movie theaters and restaurants. Although described as a retail check-out application it will be appreciated that the recovery of a portion of the cash received to be subsequently used as change back to the customer, may be equally applicable in standalone vending operations where a cashier/teller is not required. Such operations may include vending machines that accept money, as well as Credit Cards, for the purchase of food vending machines or various hard good commodities as well as tickets and lottery cards.

It should be understood that various changes and modifications to the embodiments described herein will be apparent to those skilled in the art. Such changes and modifications can be made without departing from the spirit and scope of the present disclosure and without diminishing its intended advantages. It is therefore anticipated that all such changes and modifications be covered by the instant application.

What is claimed is:

1. A secure cash management system for a point of sale location(s), comprising:
a cash server including separate and independently accessible first and second compartments therein;
a coin acceptor associated with said first compartment, said coin acceptor receiving the coins
a coin sorter for sorting the accepted coins before storing the coins within said first compartment;
a small denomination bill acceptor, also associated with said first compartment, for receiving bills equal to or below a threshold bill denomination;
a large denomination bill acceptor associated with said second compartment for receiving bills above the threshold bill denomination, recording the “deposit” of such bills, and storing the bills within an enclosure in said second compartment, said enclosure being a sealable enclosure (e.g., cassette or bag); a change terminal for dispensing change for a point of sale transaction in the form of bills equal to or below the threshold bill denomination and coins, when necessary, said change terminal including
a bill dispenser for dispensing bills equal to or below the threshold bill denomination, wherein the bills used to replenish the supply of bills in said bill dispenser are from those bills stored in the first compartment; and
a coin dispenser Wherein coins used to replenish the supply in said coin dispenser are, at least in part, from those stored in the first compartment.

2. The secure cash management system of claim 1, wherein said system further includes a display for indicating transactional and status information for the point of sale location.

3. The secure cash management system of claim 1, further including a plurality of change terminals.

4. The secure cash management system of claim 1, wherein said bill acceptors each include as bill recognition function for determining the bill denomination and a counterfeit detection subsystem.

5. The secure cash management system of claim 1, wherein said coin acceptor includes a counterfeit detection subsystem.

6. The secure cash management system of claim 1, further including signalling the requirement to remove a secure enclosure that has reached capacity.

7. A method for operating a secure cash management system, comprising:
accepng bills via a cash server;
said cash server verifying the authenticity of the bills;
determining the denomination of the bills;
storing bills equal to and below a threshold denomination in a first storage compartment;
storing, and counting, bills above a threshold denomination in a second secure compartment, separate from ail other bills or coins;
accepting coins via the cash server;
sorting coins by denomination and storing the sorted coins in the first storage compartment;
using a separate change terminal, dispensing coins and bills equal to and below a threshold denomination to the customer as required to make change for a transaction; and,
periodically replenishing the coins and bills in said change dispenser using, at least in part, coins and bills from said first storage compartment.
